(19) United States
(12) Patent Application Publication
(10) Pub. No.: US 2017/0183085 A1
(43) Pub. Date: Jun. 29, 2017

(54) System and method for controlling and monitoring aircraft equipment

(71) Applicant: DASSAULT AVIATION, Paris (FR)

(72) Inventors: Arnaud BRANTHOMME, ST REMY L'HONORE (FR); Guy SCHALLER, MARLY-LE-ROI (FR); Lorianne BOUTZEN, MEUDON (FR)

(21) Appl. No.: 15/385,966

(22) Filed: Dec. 21, 2016

(30) Foreign Application Priority Data
Dec. 24, 2015 (FR) 1502696

(51) Int. Cl. B64C 17/10; B64C 13/16; G06F 3/14; B64C 13/04

(52) U.S. Cl. CPC B64C 17/10; B64C 13/04; B64C 13/16; G06F 3/14; G06F 3/04817

(57) ABSTRACT

A system for controlling and monitoring pieces of equipment of an aircraft, each piece of equipment being able to be switched between two logic activation state values, comprising a man-machine interface, a module for configuration of a functional activation state of a function able to be performed on at least pieces of equipment of a system of the aircraft, the functional activation state being configurable between an active state and an inactive state, the configuration module being adapted for detecting an action of selection of a functional activation state of the function by an operator, and a control and monitoring module configured for determining a logic activation state of each of the pieces of equipment of the system, so that, when each of the pieces of equipment is in the determined logic activation state, the function is in the selected functional activation state.

This claims the benefit of French Patent Application FR 15 02696, filed Dec. 24, 2015 and hereby incorporated by reference herein.

The present invention relates to a system for controlling and monitoring pieces of equipment of an aircraft, each piece of equipment being switchable between at least two values of a logical activation state.

Such a system is intended to be used in a cockpit of the aircraft, in order to facilitate the work of the crew for controlling the execution of functions during the displacement of the aircraft.

It may also be applied by a remote operator of the aircraft.

### BACKGROUND

In order to control the pieces of equipment of the aircraft, a control panel (the majority of the controls being grouped in the “upper table” located at the top of the cockpit), comprising a set of control members, for example control buttons such as switches, each dedicated to a particular piece of equipment is usually made available to the crew, notably in the cockpit of the aircraft. Each control button allows an operator to control the activation of the associated piece of equipment, in particular to select an activation state for this piece of equipment from among the possible activation states, for example an operating state, wherein the piece of equipment operates in a rated mode, and a standstill state.

The pieces of equipment may be grouped per systems. On the one hand, each system may comprise several pieces of equipment able to achieve together a particular service or function. On the other hand, a piece of equipment may participate in the making of more than one function and then belong to several distinct systems.

The crew moreover has a display device (currently called “a synoptic device”), for example with one or several screens, on which may be displayed the activation and/or operating state of each of the pieces of equipment. Thus, with the majority of the systems is associated a window which may display a logical diagram of the system, and the activation and/or operating state of each of its pieces of equipment.

Such a display allows the crew to follow the activation and/or operating state of a piece of equipment, and more generally of the system(s) to which it belongs, in response to an action on the control button associated with this piece of equipment.

Each function may assume at least two distinct activation states, for example an activated state, in which the function is active, i.e. in which the pieces of equipment of the associated system carry out this function, and a deactivated state, in which the function is inactive.

In order to change the activation state of a function, for example for passing from the active state to the inactive state or for passing from the inactive state to the active state, the crew has to carry out a series of operations on the pieces of equipment of the system associated with the function, according to a predefined procedure. This procedure may be displayed in a window dedicated to the whole of the procedures.

The operations are for example actions to be executed such as controls of all or part of the equipment of the system, by means of dedicated control buttons (for example positioned on the upper table), and of verifications, by the operator, of the application of the controls on the display window (or synoptic display) associated with the system.

Thus, in order to load the activation state of a function, the operator has to transfer his/her attention successively on the window displaying the procedure to be applied for this activation or this inactivation, and then on the control panel, in order to change the activation state of a piece of equipment of the system achieving the function, and then on the window associated with this system, for verifying the taking into account of this control.

This dispersion of pieces of information and controls/monitoring operations cause a work overload for the operator, and does not allow him/her to have a global awareness of the situation, in particular of the link between the activation state of the different pieces of equipment of the system and the activation state of the associated function.

Further, in the case of failure of a piece of equipment, this failure state may be displayed without however the crew being able to be aware if the function(s) performed by this piece of equipment are affected.

The known control and monitoring systems are therefore not entirely satisfactory.

### SUMMARY OF THE INVENTION

An object of the invention is to provide a control and monitoring system, which gives the possibility of handling the pieces of equipment of the aircraft in a simplified way, by providing the pilot with a global awareness of the link between the activation and operating states of the pieces of equipment and the activation and operating states of the functions performed by means of these pieces of equipment.

For this purpose, a control and monitoring system of the aforementioned type is provided comprising:
a man-machine interface,
a module for configuration of a functional activation state for at least a function to be performed by at least two pieces of equipment of a system of said aircraft, the functional state for activating said function being configurable between at least one active state and one inactive state of said function,

said configuration module being configured for detecting an action for selecting a functional state for activating said function by an operator via said man-machine interface,
a control and monitoring module, configured for determining, from the selected functional state for activating said function, a logic state for activation of each of said at least two piece of equipment of said system, so that, when each of said at least two pieces of equipment is in the logic state of activation determined by said control and monitoring module, said function is in the selected activation functional state.

Said at least two pieces of equipment of the system of the aircraft are pieces of equipment of the aircraft. The system of the aircraft thus comprises at least two pieces of equipment, each able to be switched between at least two values of an activation logic state.

The system according to the invention may comprise one or several of the following features, taken individually or according to any technically possible combination:
said control and monitoring module is configured for sending a control signal to each of said at least two pieces of equipment of said system in order to switching each of said at least two pieces of equipment into the determined activation logic state;
said man-machine interface comprises a display device, and said system further comprises a display module, configured for controlling the display, on a window of said display device, of at least one object representative of the current functional activation state of said function;
said system is configured for performing a plurality of functions, and said display module is configured for controlling the display on said window of said display device, of a functional synoptic diagram of said system, said functional synoptic diagram comprising, for each of said plurality of functions, at least one object representative of the current functional activation state of said function;
said display device comprises a touch screen, and the man-machine interface is configured for detecting a position of a control object on said touch screen;
said display module is configured for controlling the display on said window of said display device of an actuatable icon by an operator, said action for selecting a functional activation state of said function by a user comprising an actuation of said icon;
the control and monitoring module is configured for determining, according to a current state of said system, a command for modifying the activation state of said function which has to be executed by the operator, and for controlling the display, by said display module, of said icon according to a specific representation, in order to incite an operator to modify the functional activation state of said function;
said control and monitoring module is configured for detecting a failure of a piece of equipment of said system and for determining when the failure is detected, whether said function is impacted by said failure, said display module being configured for displaying, on said window, at least one object representative of said failure and of the impact of said failure on said function;
said configuration module is adapted for detecting an action for selecting a mode of said function by an operator via said man-machine interface;
said function is configured for operating according to a manual mode, in which functional activation state of the function is selectable by an operator, or an automatic mode, in which said control and monitoring module is configured for automatically selecting the functional activation state of the function, according to predetermined criteria;
said function is a function for transferring energy or a fluid between at least two said pieces of equipment of the aircraft;
said function is a function for transferring fuel between at least two pieces of equipment of the aircraft, said at least two pieces of equipment of the system comprising at least one pump adapted for transferring fuel between said at least two pieces of equipment of the aircraft.

A method is also provided for controlling and monitoring pieces of equipment of an aircraft, each piece of equipment being able to be switched between at least two values of an activation logic state, said control and monitoring method comprising the following successive steps:
selecting by an operator, via a man-machine interface, a functional activation state of a function able to be performed by at least two of the pieces of equipment of a system of said aircraft, the functional activation state of said function being able to be configured between at least one active state and one inactive state of said function,
detecting the selection of said functional activation state,
determining, from the functional activation state of said selected function, an activation logic state of each of said at least two pieces of equipment of said system, so that, when each of said at least two pieces of equipment is in the determined activation logic state, said function is in the selected activation functional state.

The method according to the invention may comprise one or several of the following features, taken individually or according to any technically possible combination:
said method further comprises a step for emitting a control signal intended for each of said at least two pieces of equipment of said system in order to switch each of said at least two pieces of equipment into the determined activation logic state during the determination step.
the method further comprises a step for displaying, on a window of a display device, at least one objet representative of the current activation functional state of said function.
the method further comprises a step for displaying, on said window of the display device, at least one object representative of the logic state of each of said at least two pieces of equipment of said system and/or of an operating state of each of said at least two pieces of equipment of said system.

### BRIEF SUMMARY OF THE DRAWINGS

The invention will be better understood upon reading the description which follows, only given as an example, and made with reference to the appended drawings, wherein:

FIG. 1 is a diagram illustrating a control and monitoring system according to an embodiment of the invention;

FIG. 2 is a functional diagram or synoptic diagram associated with a system of an aircraft, intended to be displayed intended for an operator by the control and monitoring system of FIG. 1, in a first configuration of the pieces of equipment of the system;

FIG. 3 is a diagram of a method according to an embodiment of the invention;

FIG. 4 is a functional diagram or synoptic diagram associated with a system of an aircraft, intended to be displayed intended for an operator by the control and monitoring system of FIG. 1, in a second configuration of the pieces of equipment of the system.

### DETAILED DESCRIPTION

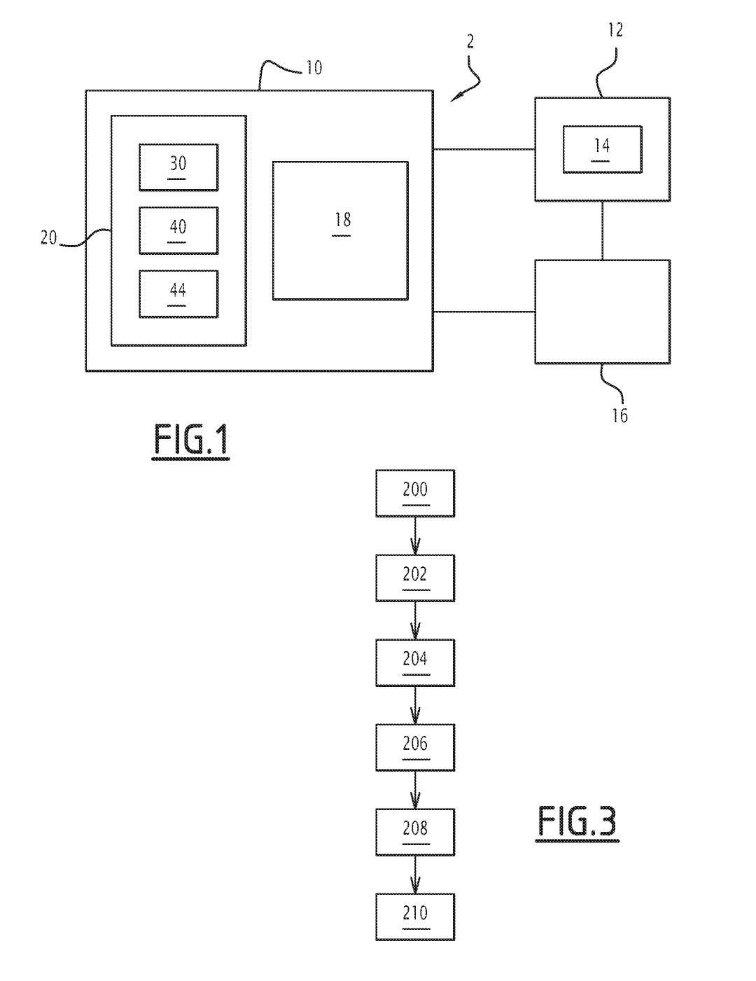

A system 2 for controlling and monitoring pieces of equipment of an aircraft according to an embodiment of the invention is schematically illustrated in FIG. 1.

This control and monitoring system 2 is for example intended to be mounted in an aircraft, notably in a cockpit, intended for the crew of the aircraft. Alternatively, the control and monitoring system 2 may also be located on the ground, notably in a ground station, and may be intended for controlling and monitoring an aircraft remotely from the ground station.

The control and monitoring system 2 is intended to allow an operator to handle functions carried out by pieces of equipment of the actuator type of the aircraft.

These pieces of equipment of the actuator type form systems. A system comprises several distinct pieces of equipment able to achieve together a particular function.

These systems are avionic systems, and notably comprise energy management systems, for example an electric system, a fuel management system, a propulsion system, and/or systems for transferring a fluid, for example a conditioning system . . . .

For example, each system may be a bleed air system (BAS), a conditioning system (ECS for “Environmental Control System”), an anti-frost system, a pressurization system, an auxiliary power unit (APU), an electric system, for example for distributing or generating electric energy, a dynamic air turbine (RAT for “RAM Air Turbine”) or a cabling system, a fire detection system, a fuel transfer system, a hydraulic system, a propulsion system (for example IPPS for “Integrated Power Plant System”), a landing system, a lighting system, an oxygen management system, a water management system, a braking management system.

Each piece of equipment of the actuator type may intervene in the performance of several functions, and even belong to two distinct systems.

Each piece of equipment of the actuator type is a piece of equipment having a physical impact on the system to which it belongs, this impact depending on the activation state of this piece of equipment.

Each piece of equipment of the actuator type may actually be switched between at least two activation logic states, called subsequently activation states, notably an operating state, in which the piece of equipment is active, and a standstill state, in which the piece of equipment is inactive.

Further, each piece of equipment may operate in a normal operating state, in which the piece of equipment operates or is able to operate in an optimal way, in a degraded operating state, which may correspond to a failure of this piece of equipment, or in a lost operating state, in which the activation state of the piece of equipment is inactive and can no longer be controlled.

Each function is achieved by several pieces of equipment of the actuator type distinct from the system to which this function is attached. In the case of the present application, by distinct pieces of equipment of the actuator type are meant pieces of equipment of the actuator type for which the activation states may be switched independently of each other.

Further, pieces of equipment associated with a function will subsequently be called pieces of equipment able to achieve together this function, and a system associated with a function will designate the system comprising these pieces of equipment.

Each function may assume at least two functional activation states, also subsequently called activation states, for example an active state, in which the function is produced by associated pieces of equipment, and an inactive state, in which the function is not produced by the associated pieces of equipment.

The activation state of each function notably depends on the activation and operating state of each of the pieces of equipment associated with this function.

The functions are for example energy transfer functions between at least two pieces of equipment, notably electrical, hydraulic, fuel, air volumes transfer functions or for transferring mechanical energy.

In this case, the active state of the function corresponds to an active energy transfer between at least two pieces of equipment, while the inactive state of the function corresponds to an absence of energy transfer between these pieces of equipment.

The functions may also comprise energy storage or transformation functions.

At least some of the functions may operate according to a manual mode, wherein the activation state of the function may be manually modified by an operator, and an automatic mode, wherein the activation state of the function is automatically modified by the control and monitoring system 2.

Further, each function may operate according to at least two operating states, notably a normal state (without any limitation), and at least one degraded state, for example a degraded state with a safety margin, a degraded state without any safety margin, also called an emergency state, and a lost state. The normal and degraded operating states may be ascertained that the function is in the active or inactive activation state. More generally, the activation state of a function and its operating state may be independent of each other.

In the normal operating state, the function is performed or may be performed in a rated way, without any limitation.

In a degraded operating state, the use of the function generates limitations.

A degraded operating state of a function may result from a failure of a piece of equipment participating in this function. In particular, a function may be degraded if one of its pieces of equipment is unavailable following a loss of its resource (for example electrical resource).

Moreover, each function may be controllable or non-controllable.

When the function is controllable, the activation state of the function may be configured from the active state to the inactive state, and conversely from the inactive state to the active state.

When the function is non-controllable, the activation state of the function cannot be modified, i.e. the function is blocked in the active state or in the inactive state.

In particular, a lost operating state of a function is a state in which the function is in the inactive state and is not controllable.

The activation state and the (automatic or manual) mode of a function may be configured by an operator by means of the man-machine interface 16.

On the other hand, the operating state (normal, degraded, etc.) and the controllable or non-controllable nature of a function cannot be modified by an operator, but are characteristics of the function ascertained by the control and monitoring system 2.

The control and monitoring system 2 is configured so as to allow an operator to control the activation state and the manual or automatic mode of the functions of the different systems of the aircraft, and for accordingly controlling the activation states of the pieces of equipment associated with these functions.

The control and monitoring system 2 is also configured in order to inform the operator on the activation state, on the manual or automatic mode, on the current operating state, and on the controllable or non-controllable nature of these functions.

The control and monitoring system 2 comprises a central processing unit 10, a display device 12 and a man-machine interface 16.

The display device 12 comprises a screen 14 and means for processing the graphic information, for example a graphic processor and an associated graphic memory.

The graphic processor is adapted for processing the graphic information stored in the graphic memory and for producing the display on the screen 14 of this piece of information or of a representation of the latter.

The man-machine interface 16 is notably intended to allow control of the activation state and of the mode of the different functions associated with the systems by an operator, for example a member of the crew of the aircraft.

The man-machine interface 16 for example comprises a tactile control device, configured for detecting the position of one or several members, subsequently called control members, on a surface of this tactile control device.

In a known way, these control members may be a stylus or the fingers of an operator.

In the continuation of the description, an embodiment will be considered in which this tactile control device and the screen 14 have a common shape, as a touch screen.

Thus, the man-machine interface 16 is configured for detecting the position of one or several control members, on the surface of the screen 14.

Certain tactile control device technologies give the possibility of detecting the position of control members without there existing a contact between the control member and the surface of the tactile control device. Subsequently, the expression “on” a surface or “on” a screen will have to be understood as meaning “on or in proximity to” this surface or this screen.

The central processing unit 10 is adapted for executing applications required for operating the control and monitoring system 2.

The central processing unit 10 comprises for this purpose a processor 18 and one or several memories 20.

The processor 18 is adapted for executing applications contained in the memory 20, notably an operating system allowing standard operation of a computer system.

The memory 20 comprises different memory areas notably containing pieces of information relatives to the different systems of the aircraft and applications intended to be executed by the processor 18.

The pieces of information relative to the systems of the aircraft notably comprise, for each system, pieces of information relative to the pieces of equipment of this system, in particular the possible activation and operating states for each of these pieces of equipment.

These pieces of information also comprise, for each function which may be performed by a system, at least one procedure giving the possibility of modifying the activation state and/or the mode of this function.

Each procedure generally comprises a series of operations applied on one or several pieces of equipment of the system associated with the function, in order to modify the activation state and/or the mode of the function.

This series of operations generally comprises controls for modifying activation states of the pieces of equipment, followed by a verification of the application of these controls.

This series of operations is generally ordered.

The memory 20 comprises a display application 30, intended to allow an operator to follow and/or control the activation state, the operating state and the mode of the functions of the systems of the aircraft.

The memory 20 moreover comprises a configuration application 40, able to detect a selection action of an activation state and/or of a mode of these functions by an operator.

The memory 20 further comprises a control and monitoring application 44, configured for monitoring and controlling the pieces of equipment of the systems, notably in response to a command from an operator.

The display application 30, subsequently called a display module 30, is configured for controlling the display, on a dedicated window of the screen 14, for each system, of a functional synoptic diagram representative of this system.

In particular, this functional synoptic diagram comprises, for each function able to be produced by the system, a representative object of the activation state and the current mode of this function.

Each object comprises for example an icon representative of the function and one or several alphanumerical symbols or indications associated with this icon.

Each function is represented on this functional synoptic diagram by an object having at least one first attribute, indicative of the current activation state of the function.

This object has at least a second attribute, indicative of the mode of the function and/or at least a third attribute, indicative of the operating state of the function and/or at least one fourth attribute, indicative of the controllable or non-controllable nature of the function.

The display of such attributes gives the possibility of limiting the interpretation required for becoming aware of the situation, and thus allows the operator to rapidly become aware of the situation.

In particular, in the case of failure of a piece of equipment, the display module 30 is able to signal the function(s) which no longer operate in a normal operating state accordingly of this failure, which allows the operator to directly view which are the functions which are impacted, and therefore limit the work burden for the operator.

A degraded, emergency or lost operating state of a function may be signaled when the function is active or when the function is inactive.

The signaling of a degraded, emergency or lost operating state of a function, when this function is active, allows an operator to become aware of the fact that this function may induce limitations since it is carried out incompletely.

The signaling of a degraded, emergency or lost operating state of a function, when this function is inactive, gives the possibility of informing an operator on the fact that the function may induce limitations since it would be carried out incompletely if the latter had to be activated, or would not be able to be activated. Such signaling therefore allows an operator to anticipate future malfunctions of a function.

Moreover, when a function is non-controllable, for example blocked in the active state or in the inactive state, the signaling of this non-controllable nature allows the operator to anticipate future absence of any response from the system subsequently to a control for modifying the activation state of the function.

As described in more details hereafter within the scope of an example, an energy transfer function is for example illustrated on the functional synoptic diagram by an arrow symbolizing this energy transfer.

The first attribute, indicative of the current activation state of the function, is then for example a color of the arrow and/or a kind of plot of the arrow, and/or an alphanumerical indication displayed facing the arrow and the contents of which and/or the display type depends on the current activation state of the function.

The second attribute, indicative of the mode of the function, and the fourth attribute, indicative of the controllable or non-controllable nature of the function, are for example alphanumerical indications.

When the energy transfer is active, the arrow is for example illustrated by a solid line or by a dotted line, notably of a green color.

According to this example, when the energy transfer function is inactive, the arrow is for example illustrated by a dashed line, notably of a grey color.

Moreover, two or three alphanumerical indicators are positioned facing each arrow, the color of these indicators being indicative of the activation state and/or of the mode of the function. Notably, a first indicator, for example “OFF”, is associated with an inactive activation state, in a manual mode, a second indicator, for example “ON”, is associated with an active activation state, in a manual mode, and a third indicator, for example “AUTO”, is associated with an automatic mode, whether the activation state is active or inactive.

When the function is inactive in a manual mode, the first alphanumerical indicator is displayed in green, the second and third indicators being displayed in grey. When the function is active in a manual mode, the second alphanumerical indicator is displayed in green, the first and third indicators being displayed in grey. When the function is in an automatic mode, whether the activation state is active or inactive, the third alphanumerical indicator is displayed in green, the first and second indicators being displayed in grey.

The third attribute, indicative of the operating state of the function, for example comprises a specific color of the object associated with the function, for example in the case of an energy transfer function, a specific color of the arrow representative of this energy transfer, for example an orange color when the function is degraded.

The third attribute preferably also comprises a type of display specific of the alphanumerical indicator representative of the activation state and/or of the mode of the function.

For example, a normal operating state is signaled by green or gray alphanumerical indicators depending on the current activation state and on the current mode. A degraded operating state is signaled by an orange frame surrounding the alphanumerical indicators, the color of the latter being green or gray depending on the current activation state and on the mode of the function. A lost operating state is signaled by a line crossing out the indicator associated with the current activation state and with the current mode of the function. In this lost operating state, the function is not controllable.

Moreover, when a function is not controllable, a specific color of the alphanumerical indicator associated with the activation state or with the selected mode gives the possibility of signaling whether the current activation state and the current mode of the function are compliant with the activation state and with the selected mode.

Preferably, the display module 30 is also configured for controlling the display on the window, for at least certain of the functions, in particular for at least an energy transfer function, of at least one control object which may be actuated by an operator, by means of the touch screen 14, in order to modify the activation state and/or the mode of this function.

For example, the actuation of this object by an operator is intended to control activation or deactivation in a manual mode of the function, or a selection of the automatic mode for the function.

Preferably, the display module 30 is configured for displaying this control object according to a specific representation, for example highlighted, when a modification of the activation state of the function is recommended, in order to incite the operator to modify the activation state of the function.

Subsequently to such a control action from an operator, and subsequently to a modification of the activation state and/or of the mode of a function by the control and monitoring system 2 in response to this actuation, the display module 30 is able to update on the screen 14 the display type of the object representative of this function.

Notably, the display module 30 is able to update the first attribute of this object, indicative of the current activation state of the function and/or its second attribute, indicative of the mode of the function.

Such updating allows the operator to become aware that his/her control action has been taken into account, and of the actual modification of the activation state and/or of the mode of the function.

As described in more details hereafter, subsequently to an action for modifying the activation state of a function, the control and monitoring module 44 is able to control the activation state of the pieces of equipment achieving this function so that the activation state of the function is the one selected by the operator.

Preferably, subsequently to such a modification action, the display module 30 is configured for displaying on the window dedicated to the system associated with the function, for each of the pieces of equipment achieving this function, an object representative of the activation and operating state of this piece of equipment.

These objects are preferably displayed temporarily, i.e. during a predetermined period, in order not to overload the display window since they correspond to logic and non-functional elements.

Such a display allows the operator to become aware of the modifications of the logic activation states carried out in order to modify the activation state of the function, and therefore improving his/her awareness of the situation.

Such a display also allows the operator to understand the operation of the system, in order to be able to manually control each of the pieces of equipment of the system in the case of a failure.

Moreover, when a function is in a degraded, emergency or lost operating state subsequent to a failure of a piece of equipment associated with this function, the display module 30 is adapted for signaling this failure, for example by displaying an object representative of the degraded operating state of this piece of equipment.

Preferably, when such a failure occurs, the display module 30 displays an object representative of the operating state of each piece of equipment associated with the function found in a degraded operating state following this failure.

Such a display allows an operator to become aware of the relevant piece(s) of equipment when a function is in a degraded, emergency or lost operating state, by minimizing the work burden required for the operator.

The display module 30 is therefore able to control the display on the screen 14, at each instant, of relative pieces of information:
in the current, active or inactive activation state, to functions applied by a system,
in the manual or automatic mode, of these functions,
in the normal, degraded or lost operating state of these functions,
in the activation and operating states of pieces of equipment of the system, at least when these pieces of equipment are in a degraded or lost operating state or participate, with another piece of equipment in a degraded or lost operating state, in the application of a function,
to the controllable or non-controllable nature of these functions.

Preferably, the display module 30 is also configured for displaying a logic synoptic diagram of a system in addition to the functional synoptic diagram.

On such a logic synoptic diagram, each piece of equipment is represented by a specific object, and the different objects are connected together as are the pieces of equipment in the system.

The display of such a logic synoptic diagram for example allows an operator, subsequently to an incident, of analyzing a posteriori this incident. Indeed, the course of a procedure subsequent to a failure should only involve the functional synoptic diagram.

Such a logic synoptic diagram is for example displayed in response to a command from an operator on a dedicated control icon, or automatically, for example in the case of failure.

This logic synoptic diagram may be displayed additionally or as a replacement of the functional synoptic diagram of the system.

The configuration application 40, subsequently called a configuration module 40, is able to detect an action for selecting an activation state of the function by an operator via the man-machine interface 16.

This selection action for example comprises an actuation of the actuatable object associated with the function by an operator, by means of the man-machine interface 16, in particular by means of the touch screen 14.

Preferably, the configuration module 40 is also configured for detecting a selection action of a mode of the function by an operator via the man-machine interface 16.

Moreover, the configuration module 40 is also configured for detecting an action for selecting an activation state of a piece of equipment.

The control and monitoring application 44 for the pieces of equipment of the system, called subsequently a control and monitoring module 44, is configured for verifying in real time the activation state (on/off) of each of the pieces of equipment of the system and the operating state (normal, degraded, etc.) of these pieces of equipment.

The control and monitoring module 44 is also configured in order to infer, from the activation and operating states of the pieces of equipment of the system, the activation state and the operating state of the functions applied by this system.

In particular, when a failure occurs on a piece of equipment, the control and monitoring module 44 is able to detect this failure and to infer therefrom which are the functions of the system which are impacted by this failure, notably which functions are in a degraded, emergency or lost operating state.

The control and monitoring module 44 is configured for transmitting these pieces of information to the display module 30, in particular the activation state, the mode, the operating state and the controllable or non-controllable nature of each of the functions, in order to display with the display module 30, on the screen 14, these pieces of information.

Moreover, the control and monitoring module 44 is configured for controlling the activation states of the different pieces of equipment of a system, depending on an activation state of one or several functions applied by this system selected by an operator and detected by the configuration module 40.

Notably, the control and monitoring module 44 is configured in order to determine, from a selected activation state of a function, as detected by the configuration module 40, the logic activation state of each piece of equipment of the system giving the possibility of attaining this functional activation state.

In particular, the control and monitoring module 44 is configured in order to determine, from the selected functional activation state and from the current logic operating state of the pieces of equipment of the system associated with the function, a series of operations to be applied in order to switch the activation state of the function from its current activation functional state to the selected functional activation state.

This series of operations for example includes controls for modifying logic activation states of at least two pieces of equipment of the system, followed by a verification of the application of these commands. Each series of operations is determined by the control and monitoring module 44 according to a procedure associated with the function, stored in the memory 20.

Moreover, the control and monitoring module 44 is configured so as to apply this series of operations, by successively send to the pieces of equipment associated with the function a control signal, in order to switch these pieces of equipment in the logic activation state adapting to the selected functional activation state.

Further, the control and monitoring module 44 is able to verify, after sending each command to a piece of equipment, that this command has been received and taken into account by the piece of equipment. In certain cases, an activation state or a mode selected by an operator for a first function is incompatible with the activation state or the current mode of a second function. Such an incompatibility may for example occur when two functions are with exclusive activation, i.e. when the activation of a function requires the deactivation of another function.

In such a case, the control and monitoring module 44 is able to detect such an incompatibility, and to modify the activation state and/or the mode of the second function accordingly while informing the operator on such a derived effect.

At the end of the modification of the activation state and/or of the mode of a function, the control and monitoring module 44 is configured for verifying the current activation state and the current mode of this function, and for transmitting to the display module 30 the current activation state and the current mode of the function, in order to modify the first attribute and/or the second attribute of this function on the screen 14.

Moreover, when the automatic mode is selected for a function, the control and monitoring module 44 is able to select automatically the activation state of this function, according to predefined procedures.

Further, when the manual mode is selected for a function, thee control and monitoring module 44 is configured for determining, depending on the current state of the system and on these procedures, a command for modifying the activation state of this function which has to be executed by the operator, and for controlling the display, with the display module 30, of the control object associated with this command according to a specific representation, for example highlighted, in order to incite the operator to modifying the activation state of the function. The command determined by the control and monitoring module 44 is for example a command which would be selected by the control and monitoring module 44 if the function was in an automatic mode.

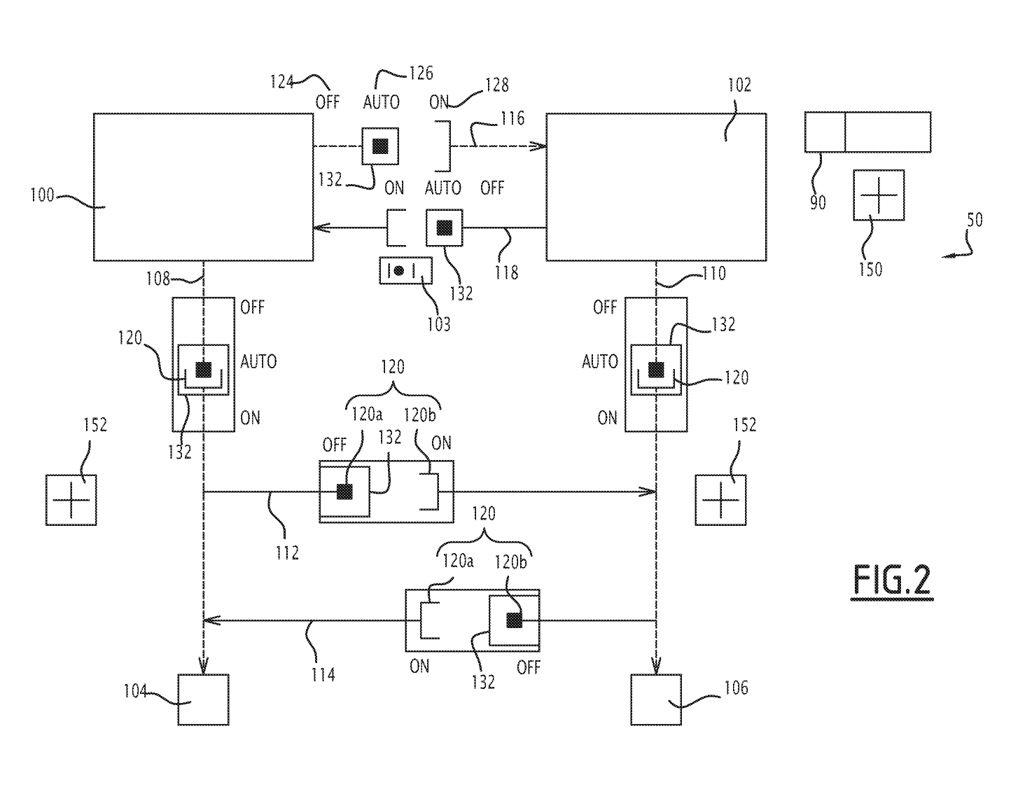

As an example in FIG. 2, a functional synoptic diagram is illustrated, able to be represented by the display module 30 on a window 50 of the screen 14.

The functional synoptic diagram illustrated in FIG. 2 is relative to a fuel management system.

This system is able to apply several distinct functions, in particular energy storage or transformation functions, and energy transfer functions.

For this purpose, the system comprises several pieces of equipment, notably a first and a second set of fuel tanks, each set of tanks being associated with a fuel storage function.

The system moreover comprises a first and second engines, each able to be supplied with fuel by at least one of the sets of tanks and for measuring the energy provided by this or these sets of reservoirs of mechanical energy.

The system moreover comprises several pumps, able to transfer fuel from one given set of tanks to the other set of tanks or to an engine or several engines of the aircraft.

For example, the system comprises a first set of pumps configured for transferring fuel from the first set of tanks to a first engine of the aircraft and/or to the second set of tanks, and a second set of pumps configured for transferring fuel from the second set of tanks to a second engine and/or to the first set of tanks.

Each set of pumps for example comprises a first pump and a second pump, which may be actuated together or separately.

As illustrated in FIG. 2, each function able to be carried out by the system is illustrated on the functional synoptic diagram by an object representative of this function and of the current activation state of this function.

The functional synoptic diagram illustrated in FIG. 2 moreover comprises a button 90 which may be actuated between a first position corresponding to an automatic mode in which all the functions may be in an automatic mode, are in this mode, with an activation state of the functions which cannot be changed manually, and a manual mode in which the activation state of the functions may be modified by an operator. In FIG. 2, the manual mode is selected.

Fuel transfer functions are notably distinguished from among the pieces of equipment of the system of the functions for use or for fuel storage.

In particular, the fuel storage function performed by the first set of tanks, respectively the second set of tanks, respectively is illustrated by an object 100, 102 respectively, which is for example of a polygonal shape. This object is partly colored, the colored proportion of the object being representative of the filling level of the set of tanks.

An indicator 103 of the balancing of the fuel mass between both sets of tanks is also illustrated on the functional synoptic diagram.

This indicator 103, with the shape of a bubble level, allows an operator to view a possible imbalance of the fuel mass, and of accordingly controlling a transfer fuel between the sets of tanks of the aircraft. This indicator views a function for balancing the fuel mass. A more global function for managing the center of gravity may also involve the mass and the position of the passengers, of the luggage, etc.

Moreover, the energy transformation functions performed by the engines are each illustrated with an object 104, 106.

Each energy transfer function, which in this example is a fuel transfer function, is illustrated by an arrow oriented in a predetermined direction. This arrow connects two objects illustrating another function or a piece of equipment, the direction of the arrow being representative of the direction of the energy transfer.

In the example illustrated in FIG. 2, six distinct functions for energy transfer are illustrated, as six arrows.

A first arrow 108 connects the object 100 representative of the fuel storage function of the first set of tanks to the object 104 representative of the energy transformation function by the first engine. The first arrow 108 is oriented towards the object 104.

In an identical way, a second arrow 110 connects the object 102 representative of the fuel storage function of the second set of tanks to the object 106 representative of the energy transformation function by the second engine. The second arrow 110 is oriented towards the object 106.

The first arrow 108 and the second arrow 110 thereby symbolize the fuel transfer function of the first set of tanks towards the first engine and the fuel transfer function of the second set of tanks towards the second engines respectively.

A third arrow 112 and a fourth arrow 114 connect the first arrow 108 to the second arrow 110, the third arrow 112 being oriented towards the second arrow 110 and the fourth arrow 114 being oriented towards the first arrow 108.

The third arrow 112 and the fourth arrow 114 symbolize the fuel transfer function of the first set of tanks towards the second engine and the fuel transfer function of the second set of tanks towards the first engine, respectively.

A fifth arrow 116 and a sixth arrow 118 connect together both objects 100, 102 representative of the fuel storage function of the first and of the second sets of tanks, the fifth arrow 116 being oriented towards the object 102 and the sixth arrow 118 being oriented towards the object 100.

The fifth arrow 116 and the sixth arrow 118 symbolize the fuel transfer function of the first set of tanks towards the second set of tanks and the fuel transfer function of the second set of tanks towards the first set of tanks, respectively.

The different objects representative of the functions performed by the system as illustrated in FIG. 2 have at least one attribute indicative of the current activation state, either active or inactive, of the associated function, and the current operating state, either normal or degraded, etc. of this function.

Preferably, each of the arrows 108, 110, 112, 114, 116 and 118, representative of an energy transfer function, has at least one first attribute, indicative of the current activation state of the function, at least one second attribute, indicative of the mode of the function, at least one third attribute, indicative of the operating state of the function, and at least one fourth attribute, indicative of the controllable or non-controllable nature of the function.

The first attribute is for example a color of the arrow and/or a type of plot of the arrow, and/or an alphanumerical indication displayed facing the arrow and the contents and/or the display mode of which depends on the current activation state of the function.

For example, the arrow is illustrated by a discontinuous line but not interrupted, notably of a green color, when the function is active. According to this example, when the energy transfer function is inactive, the arrow is for example illustrated by an interrupted line, notably of grey color.

In the example illustrated in FIG. 2, the arrows 108 and 110 are illustrated by a dotted line, which means that the fuel transfer from the first set of tanks to the first engine is active, and that the fuel transfer from the second set of tanks to the second engine is also active.

On the other hand, the arrows 112, 114, 116 and 118 are illustrated by an interrupted line, which means that no fuel transfer between the first and second sets of tanks, between the first set of tanks and the second engine, or between the second set of tanks and the first engine, takes place.

Moreover, each arrow 108, 110, 112, 114, 116 and 118 is provided with a symbol 120 of the connector type, placed along the arrow. Each symbol 120 comprises a first portion 120a, as a male connector, for example square-shaped, and a second portion 120b, as a female connector, for example hook-shaped.

The relative position of the first 120a and second 120b portions of a connector 120, is indicative of the activation state of the associated function.

Notably, when the function is active, the first 120a and second 120b portions of the connector are fitted into each other, as illustrated on the arrows 108 and 110. When the function is inactive, the first 120a and second 120b portions of the connector 120 are away from each other, notably facing each other on the interrupted line of the arrow, as illustrated on the arrows 112, 114, 116 and 118.

Preferably, the color of a connector 120 is also indicative of the activation state of the associated function and/or of the controllable or non-controllable nature of this function. Thus, the fourth attribute, indicative of the controllable or non-controllable nature of a function, is for example formed with a specific color of the connector 120.

For example, when the function is controllable and active, the connector 120 is of a green color, and when the function is controllable and inactive, the connector 120 is of a grey color. When the function is non-controllable, whether it is active or inactive, the connector 120 is for example of an orange color.

Further, with each arrow 108, 110, 112, 114, 116 and 118 is associated with at least one alphanumerical indicator, indicative of the activation state of the function and of the mode of this function.

For example, as illustrated in FIG. 2, two or three alphanumerical indicators are positioned facing each arrow 108, 110, 112, 114, 116 and 118. A first indicator 124, for example “OFF”, is intended to signal an inactive state of the function in a manual mode, a second indicator 126, for example “AUTO”, is intended to signal an automatic mode of the function, independently of its activation state, and a third indicator 128, for example “ON” is intended to signal an active state of the function in a manual mode. The first, the second and third indicators are successively positioned from the upstream side towards the downstream side of the arrow.

Preferably, the three indicators 124, 126 and 128 are displayed simultaneously when the automatic mode is selected, and this mode is signaled by displaying the indicator 126 representative of the automatic mode of the function in a predetermined color, for example in green, the other indicators 124, 128 being displayed in another predetermined color, for example in grey.

Moreover, when one of the active or non-active states is selected in the manual mode, only the two indicators 124 and 128 may be displayed, the current activation state of the function being signaled by displaying the indicator 124 or 128 representative of this activation state in a predetermined color, for example in green, the other indicator 128 or 124 being displayed in another predetermined color.

Thus, on the diagram of FIG. 2, the functions illustrated by the arrows 108, 110, 116 and 118 are in an automatic mode, while the functions illustrated by the arrows 112 and 114 are in a manual mode, and in an inactive activation state.

Moreover, each arrow 108, 110, 112, 114, 116 and 118 comprises a control object 132 for the current activation state of the associated function via the mode of this function. This object 132 may be displaced by an operator along the associated arrow between an inactivation position of the function in a manual mode, a position for passing into an automatic activation/inactivation mode, and a position for activation of the function in a manual mode.

In the inactivation position in a manual mode, the object 132 is positioned facing the indicator 124 intended to signal an inactive activation state of the function.

In the activation position in a manual mode, the object 132 is positioned facing the indicator 128 intended to signal an active activation state of the function.

In the position for passing into an automatic mode, the object 132 is positioned facing the indicator 126 intended to signal automatic management of the activation state of the function.

The control object 132 for example comprises as a square surrounding the first portion 120a of the connector 120 associated with the function, as illustrated in FIG. 2.

The control object 132 may be moved between the three positions by an operator by means of the man-machine interface 16, in particular by moving a control member on the touch screen 14 from the area of this screen displaying the control object 132 towards the targeted position for this control object.

Such a displacement of the control object 132 allows an operator to select a selected activation state of the associated function via one of its available modes.

The third attribute is for example a specific color of the arrow and/or an alphanumerical indication displayed facing the arrow and the contents of which is only displayed when the operating state of the function is degraded, an emergency or lost state. Notably, in a normal operating situation, the color of the arrow is the one associated with the normal operating state of the function, i.e. green or grey according to its activation state, and in a degraded, emergency or lost operating state, the arrow is of an orange color.

Moreover, the window 50 displays a control icon 150 which may be actuated by an operator, and for which the actuation gives the possibility of displaying, as a replacement or as an addition of the functional synoptic diagram, a logic synoptic diagram of the pieces of equipment of the system.

The window 50 moreover displays control icons 152 which may be actuated by an operator, and for which the actuation gives the possibility of displaying an object representative of the logic activation and operating states of certain pieces of equipment of the system, for example associated with a particular function.

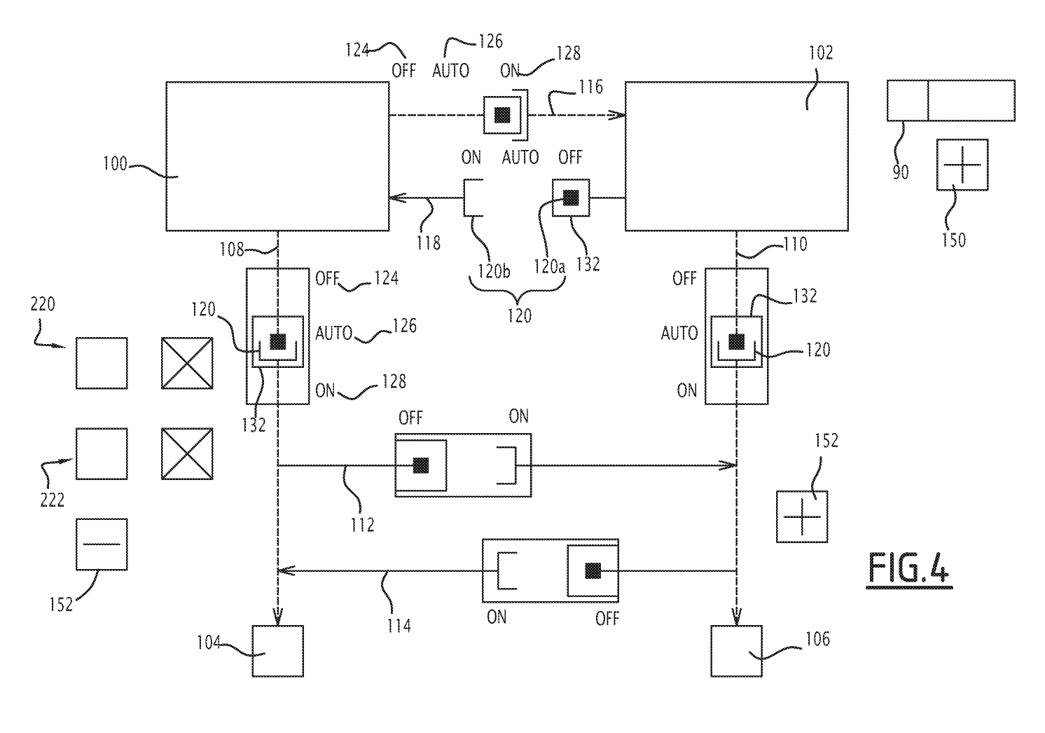

An example of application of a method for controlling pieces of equipment of a system of an aircraft by means of the control and monitoring system 2 will now be described with reference to FIG. 3, which is a diagram for applying this method, and to FIGS. 2 and 4, which illustrate a window displayed on the screen 14 intended for the pilot during the application of this method.

This example is described within the scope of the control of the fuel storage system described with reference to FIG. 2.

In the example of application of the method described, an initial condition 200 of the system is considered which is the one illustrated in FIG. 2.

In this initial state, the display module 30 controls the display, on a window of the screen 14, on a functional synoptic diagram representative of the activation state of the functions applied by the system, as illustrated in FIG. 2.

In this initial state 200, only the fuel transfer functions of the first and second set of tanks towards the first and second engines respectively, illustrated by the arrows 108 and 110, are active.

The fuel transfer functions between the two sets of tanks, illustrated by the arrows 116 and 118, are in the automatic mode with an inactive activation state.

The fuel transfer functions between the first set of tanks and the second engine and between the second set of tanks and the first engine, illustrated by the arrows 112 and 114 respectively, are in the manual mode with an inactive activation state.

In a step 202, an operator selects, via the man-machine interface 16, an activation state of one of the functions of the system, in order to modify this activation state. For this purpose, the operator moves the control object 132 of the activation state of this function from its current position courante to the selected position.

For example, if, in spite of the automatic management of the fuel balancing, an imbalance of the fuel masses between the first and second sets of tanks is ascertained, an operator activates in a manual mode the fuel transfer function from the first set of tanks to the second set of tanks, by displacing the control object 132 associated with the arrow 116 of its current position, i.e. facing the indicator 126 of the automatic mode, towards a position facing the indicator 128 of the active activation state.

In this example, the modification of the selected activation state also corresponds to a modification of the mode of the function, from the automatic mode to the manual mode.

During a step 204, the configuration module 40 detects this selection action for the activation state.

In the example described for activation of the fuel transfer function from the first set of tanks to the second set of tanks, the configuration module 40 detects the modification of the activation state from the inactive state to the active state, and the modification of the automatic mode to the manual mode which is associated with it.

Next, during a step 206, the control and monitoring module 44 determines, from the selected functional activation state for the transfer function, a logic activation state of each of the pieces of equipment of the system associated with this function, so that, when each of these pieces of equipment is in the logic activation state determined by the control module, the function is in the selected functional activation state.

In particular, during step 206, the control and monitoring module 44 determines, from the selected functional activation state and from the current logic operating state of the pieces of equipment of the system associated with the function, a series of operations to be applied in order to switch the activation state of the function from its current activation state to the selected activation state.

This series of operations is determined by the control and monitoring module 44 according to a procedure associated with the function, stored in the memory 20.

During step 206, the control and monitoring module 44 verifies whether the selected activation state for the function is compatible with the current activation state and/or with the current mode of the other functions applied by the system.

If an incompatibility between the selected activation state for the function and the current activation state and/or with the current mode of a second function is detected, the control and monitoring module 44 detects this incompatibility.

The control and monitoring module 44 modifies the activation state and/or the mode of the second function accordingly, and informs the display module 30 on this modified activation state and/or on this modified mode.

As a response, the display module 30 moves the control object 132 associated with this second function from its current position to a position facing the indicator 124, 126 or 128 corresponding to the modified activation state and/or to the modified mode.

For example, in order to activate the fuel transfer function from the first set of tanks to the second set of tanks, the control and monitoring module 44 determines the logic operating state of each of the pumps of the first set of pumps allowing effective activation of this transfer function.

Further, the control and monitoring module 44 detects that the active activation state of the fuel transfer function from the first set of tanks to the second set of tanks necessarily implies an inactive activation state of the fuel transfer function from the second set of tanks to the first set of tanks.

Accordingly, the control and monitoring module 44 selects the manual mode of this fuel transfer function while retaining the inactive activation state of this fuel transfer function.

Further, the control and monitoring module 44 informs the display module 30 on this modified mode.

As a response, the display module 30 moves the control object 132 associated with this second function from its current position, i.e. facing the indicator 126, to a position facing the indicator 124 corresponding to an inactive activation state of the function in a manual mode, as visible in FIG. 4.

During a step 208, the control and monitoring module 44 applies the determined series of operations during step 206, by sending, to each of the pieces of equipment, or at least to the pieces of equipment which are not in the determined logic activation state, a logic control signal in order to switch these pieces of equipment in the determined logic activation state.

During step 208, the control and monitoring module 44 verifies, after the sending of each control signal to a piece of equipment, that this command has been received and taken into account by the piece of equipment, i.e. that the logic activation state of this piece of equipment has actually been switched into the determined logic activation state.

Further, the control and monitoring module 44 informs in real time the display module 30 on the logic activation state of the pieces of equipment associated with the function. Preferably, the display module 30 then displays, for each of these pieces of equipment, an object representative of the logic activation state of this piece of equipment.

Notably, in order to activate the fuel transfer function from the first set of tanks to the second set of tanks, the control and monitoring module 44 sends a control signal to the pumps of the first set of pumps, or at least to the pumps of this set which are not in the determined logic activation state during step 206, in order to switch these pumps into the determined logic activation state.

The control and monitoring module 44 verifies, after sending each control signal to a pump, that the logic activation state of this pump has actually been switched into the determined logic activation state.

During a step 210, the logic activation state of the pumps of the first set of pumps is then displayed on the functional synoptic diagram by the display module 30, as illustrated in FIG. 4.

Notably, two set of icons 220, 222, representative of two pumps of the first set of pumps are displayed on the functional synoptic diagram of FIG. 4. The color of these icons is representative of the logic activation state of these pumps.

Next, during a step 210, the control and monitoring module 44 verifies the activation state of the function.

If this functional activation state is compliant with the selected functional activation state, the control and monitoring module 44 transmits this piece of information to the display module 30. The display module 30 then modifies the first attribute, indicative of the activation state of the function, on the functional synoptic diagram.

In particular, as illustrated in FIG. 4, the display module 30 illustrates the arrow 116 as an interrupted discontinuous line, displays in grey the indicator 124 associated with the manual mode and with the inactive activation state, and displays in green the indicator 128 associated with the active activation state in a manual mode of the fuel transfer function from the first set of tanks to the second set of tanks.

The system and the control method described therefore give the possibility to an operator of directly controlling the functions applied by a system, without having to individually control each piece of equipment involved in the application of these functions.

Moreover, the automatic determination by the control system of the logic activation states of the pieces of equipment of a system adapted to a selected functional activation state of a function gives the possibility of facilitating the work of the crew. In particular, this automatic determination gives the possibility of avoiding systematic consulting of the procedure having to be applied for changing the desired functional activation state, and also gives the possibility of minimizing the training time required for handling of the system by an operator. Without necessarily avoiding the systematic consulting of the procedure, the latter is lightened which actually reduces the training time. This automatic determination of the logical controls also allows minimization of the risk of error.

Further, the control of a function may be achieved by an operator by exclusively referring to the screen of the display device, which facilitates the work of the operator.

The display on the display device of a functional synoptic diagram representative of a system, and of the activation state of each of the functions applied by this system moreover gives the possibility to an operator to become globally aware of the situation, in particular of the link between the logic activation state of the different pieces of equipment of the system and the associated functional activation state of the functions. Further, in the case of a failure of a piece of equipment, this functional synoptic diagram provides the operator with a specific indication of the functions which are impacted by this failure, as well as of the impact of this failure on these functions.

It should be understood that the exemplary embodiments shown above are non-limiting.

In particular, although the invention has been illustrated with reference to a fuel management system, the invention may be applied to the control and to the monitoring of other types of systems of the aircraft, notably energy management systems, for example an electric system, a fuel storage system, a propulsion system . . . .

Further, according to an alternative, the man-machine interface comprises, as a replacement of or in addition to the tactile control device, one or several control members, for example a mouse or a joystick, and/or a keyboard . . . .

In the exemplary embodiment of the invention, the display module 30, the configuration module 40 and the control and monitoring module 44 are made in the form of pieces of software stored in the memory 20 and able to be executed by the processor 18, associated with the memory 20. Alternatively, the display module 30, the configuration module 40 and the control and monitoring module 44 are at least partly made in the form of logic programmable components, or further in the form of dedicated integrated circuits, included into the control and monitoring system 2.

What is claimed is:

1. A control and monitoring system configured for controlling and monitoring pieces of equipment of an aircraft, each piece of equipment of the aircraft being switchable between at least two values of a logic activation state, the control and monitoring system comprising:
a man-machine interface;
a configuration module, configured for configuring a functional activation state of at least one function to be performed by at least two pieces of equipment of a system of the aircraft, the functional activation state of the function being configurable between at least one active state and an inactive state of the function, the configuration module being configured for detecting a selection action by an operator of a functional activation state of the function via the man-machine interface; and
a control and monitoring module, configured for determining from the functional activation state of the function selected by the operator, a logic activation state of each of the at least two pieces of equipment of the system, so that, when each of the at least two pieces of equipment is in the logic activation state determined by the control and monitoring module, the function is in the selected functional activation state.

2. The control and monitoring system according to claim 1, wherein the control and monitoring module is configured for sending a control signal to each of the at least two pieces of equipment of the system in order to switch each of the at least two pieces of equipment into the determined logic activation state.

3. The control and monitoring system according to claim 1, wherein the man-machine interface comprises a display device, and the control and monitoring system further comprises a display module, configured for controlling the display, on a window of the display device, of at least one object representative of a current functional activation state of the function.

4. The control and monitoring system according to claim 3, wherein the control and monitoring system is configured for performing a plurality of functions, and the display module is configured for controlling a display on the window of the display device, of a functional synoptic diagram of the system, the functional synoptic diagram comprising, for each of the plurality of functions, at least one object representative of a current functional activation state of the function.

5. The control and monitoring system according to claim 3, wherein the display device comprises a touch screen, and the man-machine interface is configured for detecting a position of a control object on the touch screen.

6. The control and monitoring system according to claim 3, wherein the display module is configured for controlling a display on the window of the display device of an icon actuatable by the operator, the action for selecting a functional activation state of the function by the operator comprising an actuation of the icon.

7. The control and monitoring system according to claim 6, wherein the control and monitoring module is configured for determining, according to a current state of the system, a command for modifying the activation state of the function which has to be executed by the operator, and for controlling a display, by the display module, of the icon according to a specific representation, in order to incite an operator to modify the functional activation state of the function.

8. The control and monitoring system according to claim 3, wherein the control and monitoring module is configured for detecting a failure of one of the pieces of equipment of the system and for determining, when the failure is detected, whether the function is impacted by the failure, the display module being configured for displaying, on the window, at least one object representative of the failure and of the impact of the failure on the function.

9. The control and monitoring system according to claim 3, wherein the control and monitoring module is configured for determining an operating state of the function, from among a normal operating state, in which the function can be performed in a rated way, and a degraded operating state, in which the function cannot be performed in a rated way, and the display module is configured for controlling a display, on the window of the display device, of at least one object representative of the operating state of the function determined by the control and monitoring module.

10. The control and monitoring system according to claim 3, wherein the control and monitoring module is configured for determining whether:
the function is controllable, the activation state of the function being able to be modified from the active state to the inactive state and from the inactive state to the active state, or
non-controllable, the activation state of the function being unable to be modified from the active state to the inactive state or from the inactive state to the active state,
and the display module is configured for controlling a display, on the window of the display device, at least one object representative of a controllable or non-controllable nature of the function determined by the control and monitoring module.

11. The control and monitoring system according to claim 1, wherein the function is configured for operating according to a manual mode, in which the functional activation state of the function is selectable by an operator, and an automatic mode, in which the control and monitoring module is configured for automatically selecting the functional activation state of the function, according to predetermined criteria.

12. The control and monitoring system according to claim 11, wherein the configuration module is configured for detecting an action of selection of the manual or automatic mode of the function by the operator via the man-machine interface.

13. The control and monitoring system according to claim 1, wherein the function is an energy or fluid transfer function between at least two of the pieces of equipment of the aircraft.

14. The control and monitoring system according to claim 1, wherein the function is a fuel transfer function between at least two of the pieces of equipment of the aircraft, the at least two pieces of equipment of the system comprising at least one pump configured for transferring fuel between the at least two pieces of equipment of the aircraft.

15. A controlling and monitoring method for controlling and monitoring pieces of equipment of an aircraft, each piece of equipment being switchable between at least two logic activation state values, the control and monitoring method comprising the following successive steps:
selecting, by an operator, via a man-machine interface, a functional activation state of a function able to be performed by at least two pieces of equipment of a system of the aircraft, the functional activation state of the function being configurable between at least one active state and one inactive state of the function;
detecting the selection of the functional activation state; and
determining, from the selected functional activation state of the function, a logic activation state of each of the at least two pieces of equipment of the system, so that, when each of the at least two pieces of equipment is in the determined logic activation state, the function is in the selected functional activation state.

16. The control and monitoring method according to claim 15, wherein the method further comprises emitting a control signal intended for each of the at least two pieces of equipment of the system in order to switch each of the at least two pieces of equipment into the logic activation state determined during the determination step.

17. The control and monitoring method according to claim 15, further comprising displaying, on a window of the display device, at least one object representative of a current functional activation state of the function.

18. The control and monitoring method according to claim 17, further comprising displaying, on the window of the display device, at least one object representative of the logic state of each of the at least two pieces of equipment of the system and/or of an operating state of each of the at least two pieces of equipment of the system.

19. The control and monitoring method according to claim 17, further comprising:
determining an operating state of the function, from among a normal operating state, in which the function can be performed in a rated way, and a degraded operating state, in which the function cannot be performed in a rated way, and
displaying, on the window of the display device, of at least one object representative of the operating state of the function.

20. The control and monitoring method according to claim 17, further comprising:
determining whether the function is controllable or non-controllable, the activation state of the function being able to be modified from the active state to the inactive state and from the inactive state to the active state if the function is controllable, and the activation state of the function being unable to be modified from the active state to the inactive state or from the inactive state to the active state if the function is non-controllable, and
displaying, on the window of the display device, at least one object representative of the controllable or non-controllable nature of the function.
